(19) United States
(12) Patent Application Publication
(10) Pub. No.: US 2020/0276681 A1
(43) Pub. Date: Sep. 3, 2020

(54) Tool Holder Having An Arrangement For Delivering Coolant And Transmitting Electric Power

(71) Applicant: X'POLE PRECISION TOOLS INC., Taoyuan City (TW)

(72) Inventor: Peter CHEN, Taoyuan City (TW)

(21) Appl. No.: 16/289,633

(22) Filed: Feb. 28, 2019

(51) Int. Cl. B23Q 11/10; B23Q 11/00

(52) U.S. Cl. CPC B23Q 11/1023; B23Q 2220/006; B23Q 11/0032

(57) ABSTRACT

A tool holder used in a machine which supplies power via a spindle and deliveries coolant is provided with a connector in the spindle; a conductive ring on the connector and electrically connected to the spindle so as that power is configured to supply to the tool holder; a tool mounting member including an axial hole for fastening a portion of a tool; an actuator in the tool mounting member and electrically connected to the conductive ring so that power is transmitted to the tool via the axial hole; an axial passageway through both the connector and the tool mounting member; and a waterproof dividing member for dividing the axial passageway into a first channel for delivering coolant and a second channel for passing a wire. The first channel is spaced from the second channel so that electric power transmission and coolant delivery are made independently.

### BACKGROUND OF THE INVENTION

### 1. Field of the Invention

The invention relates to relates to tool holders and more particularly to a tool holder having an arrangement for delivering coolant and transmitting electric power.

### 2. Description of Related Art

Conventional high precision machining including drilling, milling, boring, cutting and polishing often uses computer numerical control (CNC) machine as an auxiliary device in cooperation with tools such as drills, cutters, or the like. The tools are shaped as an elongated handle. A tool holder may secure the tool to the spindle of the CNC machine. The spindle rotates in high speed to rotate the tool fastened by the tool holder for machining a workpiece.

Typically, coolant is used to cool and lubricate a workpiece being machined so as to obtain the following benefits; keeping the workpiece at a stable temperature. Very warm is acceptable, but extremely hot or alternating hot-and-cold are avoided. maximizing the life of the cutting tip by lubricating the working edge. Ensuring safety for the people handling it and for the environment upon disposal. Preventing rust on machine parts and cutters. Conventionally, the coolant is delivered through a chuck or the like in a machining process.

It is known that the tool holder may vibrate strongly in machining and it may interfere with the machining, resulting in a poor quality of the finished workpiece. Further, components may collide one another resulting in undesired vibration which may interfere with the high frequency vibration. An in turn, it may adversely affect precision of the workpiece, and damage both the machine and the tool holder.

In a cutting process, any vibration between the tool holder and the workpiece may undesirably affect cutting and unsmooth surface and unacceptable quality of the workpiece. To the worse, the vibration may damage the tool holder and/or the tool. It is found that the longer of the tool holder the more serious of the vibration. Elongated tool holders are disclosed by U.S. Pat. Nos. 1,502,528, 2,716,030 and 8,821,084. For high length to diameter ratio, the precision of the workpiece may be very low or even be impossible of being machined due to rigidity of the material of the tool holder. These are problems encountered by the conventional machines. It may cause strong interference to undesirably vibrate the tool holder. The cutting effect is adversely affected. Also, smoothness and quality of the workpiece are low. To the worse, the machines are damaged.

Thus, the need for improvement still exists.

### SUMMARY OF THE INVENTION

It is therefore one object of the invention to provide a tool holder having an arrangement for delivering coolant and transmitting electric power wherein the actuator is disposed in the tool mounting member so that the path for transmitting electric power can be greatly decreased. Further, undesired vibration to the tool holder by the high frequency vibration may be eliminated. Furthermore, the inadequate rigidity of the material of the conventional tool holder having a high L/D ratio is improved. In addition, smoothness and quality of the workpiece are improved. In addition, coolant delivery through the first channel and wire passing through the second channel for transmitting electric power are made independently. Additionally, the provision of the sleeves may lengthen the tool holder if such need arises.

It is another object of the invention to provide a tool holder having an arrangement for delivering coolant and transmitting electric power wherein the inadequate rigidity of the material of the conventional tool holder having a high L/D ratio is improved, and the high L/D ratio is significantly decreased. As shown in FIG. 1, the length to diameter ratio before the installation of the actuator labeled L1/D is decreased to L/D after the installation of the actuator. Further, the provision of at least one sleeve can lengthen the tool holder while the L/D is fixed irrespective of the value of L1.

It is a further object of the invention to provide a tool holder having an arrangement for delivering coolant and transmitting electric power wherein the length of the tool holder can be changed by providing at least one sleeve interconnecting a connector and a tool mounting member.

For achieving above an other objects of the invention, there is provided a tool holder used in a machine which supplies power via a spindle and deliveries coolant, comprising a connector received in the spindle; a conductive ring disposed on the connector and electrically connected to the spindle so as that power is configured to supply to the tool holder; a tool mounting member including an axial hole for fastening a portion of a tool; an actuator disposed in the tool mounting member and electrically connected to the conductive ring so that power supplied to the actuator is configured to transmit to the tool via the axial hole; an axial passageway disposed through both the connector and the tool mounting member; and a waterproof dividing member for dividing the axial passageway into a first channel for delivering coolant and a second channel for passing a wire; wherein the first channel is spaced from the second channel so that electric power transmission and coolant delivery are made independently.

Preferably, the waterproof dividing member includes a plurality of dividing elements complimentarily secured together.

Preferably, the connector includes an axial tunnel for conveying coolant from the spindle to the first channel.

Preferably, the actuator is an oscillator for producing ultrasonic vibration, an electric device, or a pneumatic device.

Preferably, the tool mounting member further comprises a flexible chuck having the axial hole disposed therein, the flexible chuck including a plurality of lengthwise parallel slits each having an open end, and a plurality of latches each disposed between two adjacent ones of the slits; and a fastener disposed on an end of the flexible chuck so that a force exerted upon the flexible chuck is configured to flexibly deform the latches to fasten the tool in the flexible chuck.

Preferably, the tool mounting member further comprises an axial tunnel member for delivering coolant from the first channel to the flexible chuck.

Preferably, there is further provided at least one sleeve interconnecting the connector and the tool mounting member.

Preferably, each sleeve includes a projection at one end and a receptacle at the other end so that the at least one sleeve is configured to complimentarily attach to both the connector and the tool mounting member.

### BRIEF DESCRIPTION OF THE DRAWINGS

The invention, as well as its many advantages, may be further understood by the following detailed description and drawings in which:

FIG. 1 is a longitudinal sectional view of a tool holder having an arrangement for delivering coolant and transmitting electric power according to the invention; and

FIG. 2 is a detailed view of the area in right side of FIG. 1.

### DETAILED DESCRIPTION OF THE INVENTION

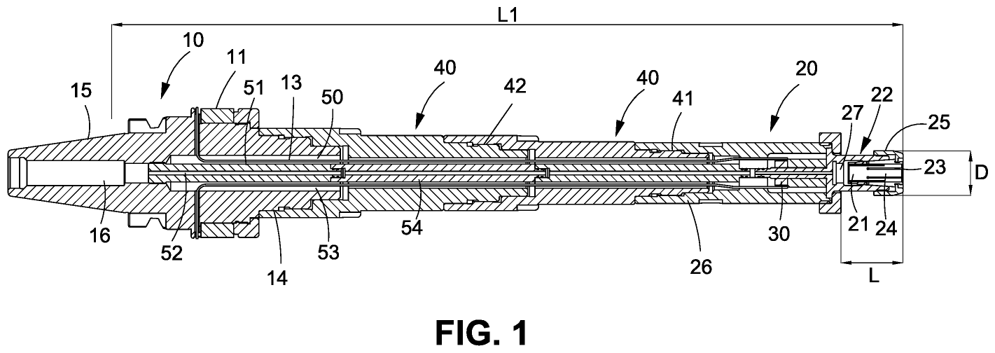

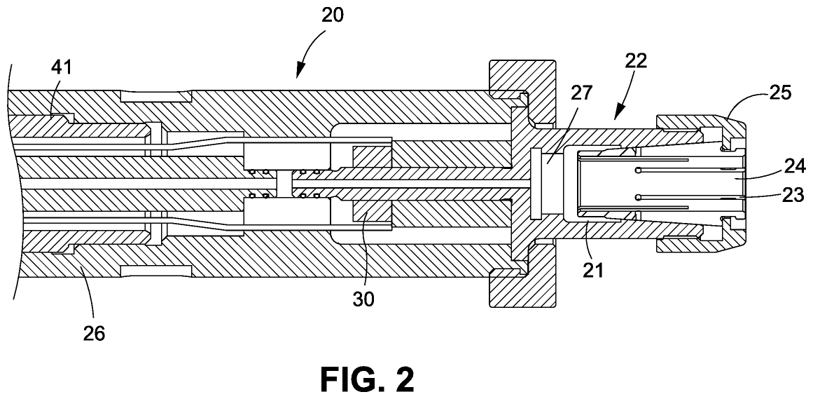

Referring to FIGS. 1 and 2, a tool holder having an arrangement for delivering coolant and transmitting electric power according to the invention is used in a machine which supplies power via a spindle (not shown). The tool holder comprises a connector 10 received in the spindle, a conductive ring 11 disposed on the connector 10 and electrically connected to the spindle so that power may be supplied to the tool holder; a substantially cylindrical tool mounting member 20 including an axial hole 21 for fastening a portion of a tool (e.g., tool handle but not shown); and an actuator 30 disposed in the tool mounting member 20 and electrically connected to the conductive ring 11 so that power may be supplied to the actuator 30. The produced vibration of high frequency is transmitted to the tool via the axial hole 21.

The tool holder further comprises an axial passageway 50 through both the connector 10 and the tool mounting member 20, and a waterproof dividing member 51 for dividing the axial passageway 50 into a first channel 52 for delivering coolant and a second channel 53 for passing a wire. The first channel 52 is spaced from the second channel 53 so that electric power transmission and coolant delivery can be made independently. As a result, the actuator 30 can greatly decrease the path for transmitting electric power.

The actuator 30 is implemented as an oscillator for producing ultrasonic vibration, an electric device, or a pneumatic device. When the actuator 30 is a pneumatic device, the conductive ring 11 can be replaced with a pneumatic member and the second channel 53 can be replaced with a gas channel by one skilled in the art.

The connector 10 has a stepped-diameter outer surface 15 which is configured to receive in the spindle of a machine. Thus, the tool holder may be aligned with the spindle to be secured together. The connector 10 includes an axial tunnel 16 for conveying coolant from the spindle to the first channel 52.

The substantially cylindrical tool mounting member 20 includes a flexible chuck 22 having the axial hole 21 formed therein, a plurality of lengthwise parallel slits 23 each having an opening at one end, a plurality of latches 24 each disposed between two adjacent ones of the slits 23, and a fastener 25 disposed on one end of the flexible chuck 22 to exert a force to flexibly deform the latches 24 so that a tool (not shown) disposed in the flexible chuck 22 can be fastened. The fastening of the tool using the flexible chuck 22 is one of a plurality of fastening methods. Those skilled in the art may be aware of other fastening methods.

The waterproof dividing member 51 includes a plurality of dividing elements 54 complimentarily secured together. Further, two ends of the waterproof dividing member 51 are secured to inside of the connector 10 and inside of the tool mounting member 20 respectively. Thus, the desired positioning and waterproof characteristics of the invention are obtained. O-rings, gaskets, washers or the like may be used to fill the space between two mating surfaces of the two adjacent dividing elements 54 (or two mating surfaces of the dividing element 54 and an adjacent member) to prevent water from the first channel 52 and/or the second channel 53 entering the joined objects while under compression. Likewise, in the implementation of conveying gas, the sealing members can prevent gas including air from entering the joined objects while under compression. This is well known to those skilled in the art.

The dividing element 54 includes the axial first channel 52 for delivering coolant having a circular section. The second channel 53 for passing a wire hole having a circular section is formed between the dividing element 54 and an inner surface of the axial passageway 50.

The tool mounting member 20 further comprises an axial tunnel member 27 for delivering coolant from the first channel 52 to the flexible chuck 22.

A wire 13 has one end electrically connected to the actuator 30 and the other end electrically connected to the conductive ring 11 by passing through the second channel 53. A non-contact conductive connection (e.g., electromagnetic induction) can be implemented between the conductive ring 11 and the spindle of the machine. Alternatively, a two-terminal conductive contact between the conductive ring 11 and the spindle of the machine can be implemented. As a result, power is supplied to the conductive ring 11. Details thereof are omitted herein for the sake of brevity.

In another preferred embodiment of the invention, there is further provided a plurality of (e.g., two) sleeves 40 disposed between the connector 10 and the tool mounting member 20. Each sleeve 40 includes a projection 41 at one end and a receptacle 42 at the other end so that the projection 41 of one sleeve 40 can be complimentarily attached to the receptacle 42 of the other sleeve 40. A protrusion 14 is provided at one end of the connector 10 for complimentarily attaching to the receptacle 42 of one sleeve 40, and a cavity 26 is provided at the other end of the tool mounting member 20 for complimentarily attaching to the projection 41 of the other sleeve 40. As a result, the connector 10, the sleeves 40 and the tool mounting member 20 are secured together. The number of the sleeves 40 can be increased or decreased depending applications. Thus, the length of the tool holder can be adjusted.

It is envisaged by the tool holder having an arrangement for delivering coolant and transmitting electric power of the invention that the actuator is disposed in the tool mounting member so that the path for transmitting electric power can be greatly decreased. Further, undesired vibration to the tool holder by the high frequency vibration may be eliminated. Furthermore, the inadequate rigidity of the material of the conventional tool holder having a high L/D ratio is improved. In addition, smoothness and quality of the workpiece are improved. In addition, coolant delivery through the first channel and wire passing through the second channel for transmitting electric power are made independently. Additionally, the provision of the sleeves may lengthen the tool holder if such need arises.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A tool holder used in a machine which supplies power via a spindle and deliveries coolant, comprising:
a connector received in the spindle;
a conductive ring disposed on the connector and electrically connected to the spindle so as that power is configured to supply to the tool holder;
a tool mounting member including an axial hole for fastening a portion of a tool;
an actuator disposed in the tool mounting member and electrically connected to the conductive ring so that power supplied to the actuator is configured to transmit to the tool via the axial hole;
an axial passageway disposed through both the connector and the tool mounting member; and
a waterproof dividing member for dividing the axial passageway into a first channel for delivering coolant and a second channel for passing a wire;
wherein the first channel is spaced from the second channel so that electric power transmission and coolant delivery are made independently.

2. The tool holder of claim 1, wherein the waterproof dividing member includes a plurality of dividing elements complimentarily secured together.

3. The tool holder of claim 1, wherein the connector includes an axial tunnel for conveying coolant from the spindle to the first channel.

4. The tool holder of claim 1, wherein the actuator is an oscillator for producing ultrasonic vibration, an electric device, or a pneumatic device.

5. The tool holder of claim 1, wherein the tool mounting member further comprises a flexible chuck having the axial hole disposed therein, the flexible chuck including a plurality of lengthwise parallel slits each having an open end, and a plurality of latches each disposed between two adjacent ones of the slits; and a fastener disposed on an end of the flexible chuck so that a force exerted upon the flexible chuck is configured to flexibly deform the latches to fasten the tool in the flexible chuck.

6. The tool holder of claim 5, wherein the tool mounting member further comprises an axial tunnel member for delivering coolant from the first channel to the flexible chuck.

7. The tool holder of claim 1, further comprising at least one sleeve interconnecting the connector and the tool mounting member.

8. The tool holder of claim 7, wherein each of the at least one sleeve includes a projection at one end and a receptacle at the other end so that the at least one sleeve is configured to complimentarily attach to both the connector and the tool mounting member.
